(19) United States
(12) Patent Application Publication
(10) Pub. No.: US 2006/0247956 A1
(43) Pub. Date: Nov. 2, 2006

(54) Risk environment modeling for predicting decisions

(75) Inventors: Daniel Jonathan Rosen, Sharon, MA (US); Bridget Bly, Summit, NJ (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: R-Squared Analytics, LLC, Sharon, MA (US)

(21) Appl. No.: 10/561,750

(22) PCT Filed: Jun. 24, 2004
(86) PCT No.: PCT/US04/20534

§ 371 Date: Jul. 6, 2006

Related U.S. Application Data
(60) Provisional application No. 60/482,067, filed on Jun. 24, 2003.

(51) Int. Cl. G06F 9/44; G06F 17/50

(52) U.S. Cl. 705/7

(57) ABSTRACT

A modeling method for predicting a decision is disclosed. A risk environment is simulated for one or more control groups. One or more experimental groups are exposed to an intervention, and the risk environment is simulated for the experimental groups.

### CLAIM OF PRIORITY

This application claims the benefit of U.S. Provisional Patent Application No. 60/482,067, entitled “A Method for Modeling and Predicting Consumer Purchase Behavior Based Upon Simulation of Real World Risk Environments,” filed on Jun. 24, 2003.

### FIELD OF THE INVENTION

The herein described systems and methods relate to modeling and predicting decision making behavior, and more particularly, to the use of risk environment modeling for predicting decisions.

### BACKGROUND

Researchers have used a variety of methods to aid the individual or organization that wishes to predict how well a product or service will sell in the marketplace, particularly in comparison to competitors' products or services. Each conventional method attempts to predict how consumers or other purchasers will behave in the future.

Conventional self-report studies include qualitative focus group studies and quantitative surveys of customer attitude and buying propensity. Data collected in self-report studies are subjects' recollections or predictions of their own or others' behavior or attitudes. These types of data define the nature of self-report studies. For example, self-report studies may attempt to measure buying propensity by showing a product or an advertisement to one or more subjects, and surveying the subjects' responses to the product or advertisement, using questions such as, “How much would you pay for the product?” Self-report studies are fundamentally limited by the fact that they rely on an individual's self-reports of attitudes and predictions of their own future behavior; accordingly, such reports are subject to bias effects and are inherently unreliable.

Classification studies, such as conventional segmentation classification/analysis of historical purchase and perception data, utilize actual historical behavioral data in place of self-reporting. A broad customer base is segmented into groups that are mutually exclusive, with groups that are as different as possible from one another, each group having members who are as similar to one another as possible. However, such studies are of limited use when attempting to predict behavior in novel situations.

Real world test marketing has also been utilized. Conventional test marketing studies include, for example, marketing a product or service on a limited basis, such as in one metropolitan area. Actual consumer purchasing information is thereby obtained, prior to marketing the product or service on a national or global basis. Test marketing studies are, to a first approximation, representative of the real world. They have the advantage of actually observing purchase behavior in the real world or a reasonable simulation of the real world. Conventional real world test marketing studies are, however, limited by cost and turnaround time.

Conventional simulated test marketing (STM) studies primarily attempt to simulate the surface features of the purchase environment faced by a consumer in a simulated purchase environment; for example, by constructing a faux market (such as a simulated convenience store environment) and allowing a test subject to walk down an aisle, choose products from shelves, and place them in a basket or cart for purchase at a cash register. The principal goal of STM studies is to directly observe subjects' decision behavior by placing subjects in an environment that closely resembles the real world decision environment. STM methods do this by re-creating the surface level characteristics of the purchase environment in the laboratory. If this surface feature recreation is done well, it is assumed that the underlying determinants of real world purchase behavior are present in the lab environment in a manner similar to their presence in the real world. For instance, researchers much time and effort ensuring that shelf placement of study items in the STM faux market matches that in actual markets. This is not done because shelf placement is, in and of itself, an important feature of the purchase decision. Rather, shelf placement is an important driver of customer awareness and attention and these core behavioral determinants must be present in the faux market experiment in a manner similar to their presence in the real world for the STM method to have validity.

Conventional STM studies are limited by the range of markets for which they can be used—generally packaged goods—and by their limited ability to accurately model the purchase environment faced by a potential consumer. STM is defined as a research method that recreates a purchase environment through a recreation of surface features of real world purchase environments. This definition limits the scope of application of STM, for practical reasons. It is practical to recreate the purchase environment for toothpaste, but not for “big ticket” items—“big ticket” being typically defined as any item carrying a price tag of approximately $100 (or its non-cash equivalent) or higher. For example, packaged good companies can typically afford to give away numerous samples of their goods, while car manufacturers cannot.

The predictive ability of conventional methods may be limited by any of numerous factors. Such factors may include absent or limited capacity to achieve the following goals: (1) identifying and accurately modeling key components of the decision environment faced by the potential purchaser; (2) applying decision environment models to big ticket items such as computers or automobiles; (3) applying decision environment models to non-cash decisions such as (but not limited to) barter agreements, political or healthcare decisions, or decisions about how to spend time and non-cash resources such as the decision to watch one television show over another; (4) performing the foregoing tasks economically and quickly; (5) accurately extrapolating from the specific study question to related questions; (6) robustly modeling the relationship between intervening variables, such as brand awareness or brand perception, and purchase behavior; (7) quickly, accurately and inexpensively predicting the effects that various interventions, such as exposure to advertising, have on purchase behavior; and (8) accurately predicting the return on investment (ROI) of an advertising or promotional campaign.

### SUMMARY

In one embodiment, the invention encompasses a modeling method for predicting a decision. A risk environment is simulated for one or more control groups. One or more experimental groups are exposed to an intervention, and the risk environment is then simulated for the experimental groups.

In an additional embodiment, the invention encompasses a method for modeling decision making behavior. A simulated risk environment is provided to one or more control groups, and the simulated risk environment is calibrated against a set of real world data. An intervention is provided to one or more experimental groups, and the simulated risk environment is also provided to the one or more experimental groups. A relationship between the intervention and a perception is modeled, and a relationship between the perception and a decision is modeled. One or more models are then calibrated against the set of real world data, and one or more predictions are obtained using the models.

A further embodiment of the invention encompasses a risk environment system for modeling a decision of a participant. The risk environment system comprises an item of value, and at least one intervention. The system further comprises a plurality of questions comprising at least one non-diversionary question and at least one diversionary question. The system also comprises a plurality of choices, which comprise at least one product choice and a non-selection choice. Finally, the system comprises an incentive having a risk associated with a selected choice and a reward associated with the selected choice.

Yet a further embodiment of the invention encompasses a simulated risk environment system for modeling a behavior of one or more subjects. The simulated risk environment system comprises at least one intervention, a plurality of questions, and a plurality of choices for spending a period of time. The system also comprises an incentive to a subject. The incentive comprises a benefit associated with a selected choice, and a cost associated with the selected choice. The cost comprises at least a portion of the period of time. The incentive also includes an opportunity cost comprising a lost benefit associated with one or more non-selected choices.

In another aspect, an embodiment of the invention encompasses a computer-readable storage medium containing a set of instructions for simulating a risk environment for one or more subjects. The instructions comprise code segments for presenting to a subject questions on one or more relevant factors, for offering to the subject a plurality of choices for the decision, for offering to the subject an incentive, and for recording a selected choice made by the subject.

In still another aspect, an embodiment of the invention encompasses a computer-implemented system for modeling at least one effect of an intervention. The system comprises a computer, and one or more software applications. The software applications comprise steps for presenting to a subject questions on one or more relevant factors, offering to the subject a plurality of choices for the decision, offering to the subject an incentive, and recording a selected choice made by the subject. The software applications also comprise steps for constructing a first model of a relationship between the intervention and a perception, constructing a second model of a relationship between the perception and a behavior, calibrating the first and second models using a set of real world data, and obtaining at least one prediction using the first and second models.

The foregoing presents a simplified summary of the invention in order to provide a basic understanding of some aspects of the invention. This summary is not an extensive overview of the invention, and is intended to neither identify key or critical elements of the invention nor delineate the scope of the invention. Other features of the invention are further described below.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is an entity relationship diagram illustrating components of a system according to an embodiment of the invention.

FIG. 2 is a flow chart illustrating an overview of a method for modeling and predicting decisions, according to an embodiment of the invention.

FIG. 3 is a flow chart illustrating data flow according to an embodiment of the invention.

FIG. 4 is a diagram of a simulated risk environment according to an embodiment of the invention.

FIG. 5 is a flow chart illustrating data collection steps according to an embodiment of the invention.

FIG. 6 is a flow chart illustrating modeling, calibration, and predicting steps according to an embodiment of the invention.

### DETAILED DESCRIPTION

Expected value modeling (EVM) uses laboratory studies of subjects making economic decisions in a risk environment that simulates the risk environment faced by purchasers in the real world. In an embodiment of the invention, a method to model and predict purchase behavior uses those studies to model the influences that various interventions have on purchase behavior. These influences may directly impact purchase behavior or work through intervening variables such as brand awareness and brand perception.

In EVM, the underlying risk/reward situation faced by a decision maker is recreated in the laboratory, regardless of whether or not the surface level features of the decision environment are present. Like conventional STM methods, embodiments of EVM may be used to directly observe subjects' decision behavior by placing subjects in an environment that resembles the real world decision environment. However, since EVM does not rely on the presence of surface level features, it is freed from the practical limitations presented by the need to recreate those features in the laboratory. In a preferred embodiment, by obviating the necessity for surface level cash equivalence between the laboratory and the real world, EVM allows for the study of both “big ticket” item and non-cash item purchase behavior.

EVM is used to generate predictions regarding purchase behavior in the “real world” using a choice-based process, rather than using self-reported attitudes and purchase intention measures. This is in keeping with the standard assumption in economics that preference is revealed through binding, consequential choices. Economists, however, view preferences as generally stable over variations in context and elicitation methods. Psychologists who study decision making, by contrast, find this approach far too restrictive. There is by now ample psychological research demonstrating the descriptive inadequacy of the standard economic model, and in particular showing that people's choices differ systematically for the same objective decision when it is framed in different ways. Taken together, the accumulated research showing that framing, context, and elicitation method all exert predictable influences on people's choices strongly suggests that people do not generally have stable preferences that are revealed in their choices; rather, the research indicates that preferences are constructed in the act of choosing and hence are influenced by how the choice is framed, the context in which it is made, and the manner in which it is elicited. People don't always know what they want, and may take cues to their preferences from the context in which the decision is made.

The psychological research, then, implies that choices made in one particular context are not necessarily predictive of choices made in another context, even if the choice options themselves are identical. A general strength of EVM, from this view, is that it attempts to better match the fundamental choice context of interest (e.g., the consumer economic/psychological purchase environment) than do alternative conventional methods such as attitude and purchase intention measures or STM, in that it involves a close simulation of the actual economic/psychological choice faced by consumers.

Choices made in the EVM procedure include an element of risk analogous to that faced by consumers in actual purchase decisions. Specifically, participants are faced with the risk of losing money (or its equivalent) if they make the wrong choice (for instance, by “purchasing” a product that is not well suited to their needs). By contrast, risk plays no role in attitude and purchase intention measures. Consumers' evaluations of perceived risk play an important role in many purchase decisions. Accurate prediction of the market for a product, therefore, will need to take into account variance among individual consumers in their attitudes toward risk, and the uncertainty associated with purchasing a particular product relative to that associated with purchasing a competing product. To the extent that attitudes toward risk and a disproportionate concern for potential losses relative to potential gains play a role in consumer decisions, the EVM procedure has an advantage in predictive accuracy over conventional measures that do not include an element of risk. By creating a laboratory model of the real world risk environment, EVM readily allows for the testing of framing effects such as individuals' differing responses to perceived losses and gains. This ability is not available with conventional methods.

A fundamental psychological principle of decision making is that choice options are evaluated in terms of potential gains and losses relative to a reference point, with potential losses exerting a larger impact than potential gains on choices. For the consumer, two natural reference points are (a) the status quo, in which the consumer currently does not own the product but has money that could be used for the purchase; and (b) the expected outcome of purchasing the preferred product. In the presence of risk, when evaluated from reference point (a), the price paid for a product may be viewed by the consumer as a potential loss (i.e., if the purchased product is later found not to meet the consumer's needs). Alternatively, when evaluated from reference point (b), any possible gap between expected and actual product performance might also be viewed as a potential loss. Loss aversion would be expected to lead consumers to make generally more conservative choices (e.g., staying with a familiar brand rather than trying a new brand) than would be suggested by the use of purchase intention measures, in which—because there is not an explicit decision to be made—potential losses are likely to be less salient.

Furthermore, choices made in the EVM procedure have real consequences for participants, which may include monetary consequences; in an exemplary embodiment, when they are asked to indicate how much they are willing to pay for a product (scaled appropriately for the purchase simulation), they are making a commitment to actually pay that amount from their own wallets. By contrast, when participants complete attitude questionnaires or purchase intention ratings, they have no particular incentive to take the task seriously or to treat their statements as in any way binding. Again, EVM better reproduces the purchase decision that consumers face by requiring participants to make choices with real consequences, including potential losses as well as gains.

One straightforward benefit of introducing real consequences is that participants are motivated to pay attention to and think carefully about the decisions posed to them in the EVM task. In addition, use of an appropriate (“incentive-compatible”) payoff scheme ensures that it is in the best interest of the participant to respond honestly; any strategic misrepresentation of the participant's genuine preferences will be costly to the participant. Purchase intention measures, by contrast, may tend to be inflated as there is no cost to overstating one's intentions to purchase the product and there may be some perceived demand from the researchers to express an interest in the product. Use of the dollar response scale, furthermore, is familiar to respondents and underscores the economic context of the decision in a manner that may better reproduce the mindset of the typical consumer faced with a real purchase decision.

In addition, choices in the EVM procedure are made in the context of a well-specified set of alternative options; for example, a particular product may be evaluated relative to a set of competing products. By contrast, conventional attitude and purchase intention measures often involve evaluation of a single option (product) in isolation. Real-world purchase decisions, of course, are typically made in the context of the set of candidate choice options under consideration by the consumer. Psychological research indicates that choices and evaluations of a choice option can vary dramatically depending on the context of other options also under consideration, suggesting that evaluations of an option in isolation may not extrapolate reliably to the prediction of how that choice option will fare in competition with other choice options. To the extent that choice context matters, EVM offers the advantage of achieving a better match to the choice context faced in the actual purchase decision of interest, and offers a cost-effective way of testing a wide variety of choice contexts—a feature not now available by conventional methods.

Psychological research suggesting that preferences are constructed in the act of choosing underscores the importance of the context of alternative choice options faced by the consumer, and highlights the challenges of eliciting coherent, reliable expressions of preference in consumer research. Generally speaking, participants are likely to provide more coherent evaluations of a product in a comparative context of the kind used in EVM, because, in an embodiment of the invention, the evaluations implicitly correspond to the participant's rank ordering of the set of available options.

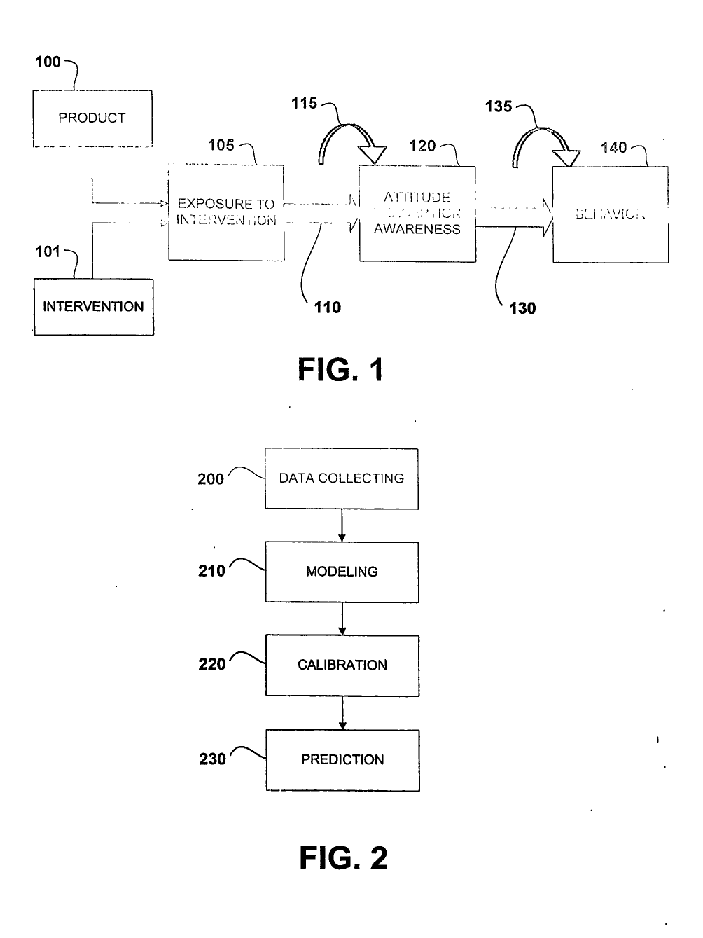

Referring to the drawings, in which like reference numerals indicate like elements, FIG. 1 is an entity relationship diagram illustrating components of a system according to an embodiment of the invention.

An aspect of the invention aids the individual or organization that wishes to predict how well a product 100, which may comprise goods, services, and the like, will sell in the marketplace, particularly in comparison to competitors' goods or services. Embodiments of the invention are also useful for determining how best to market the product 100 to various target markets and to understand which components or characteristics of the product 100 are the most important influences on purchase behavior. The invention is not limited to the study of financial transactions or purchase decisions. Rather, embodiments of the invention may be used to study any situation in which individuals or groups make decisions in a risk environment. Such situations include making choices of how to spend resources, which may include time, money, or other measures of cost or value. Making a selection from a menu of choices incurs at least opportunity costs associated with the rejection of alternative selections. For example, embodiments of the invention may be used to study decisions among entertainment activities, an exemplary product 100 being a television program to watch. Voting behavior may also be studied using embodiments of the invention, an exemplary product 100 being a candidate for office. Further illustrative examples of decision making processes that may be studied using embodiments of the invention include purchase, barter or trading decisions, medical and health care decisions, and organizational or public policymaking decisions.

Exposure to intervention block 105 represents the exposure subjects have to a particular intervention 101 being studied. Intervention 101 may be a commercial, advertisement, or promotion for a product 100, though any intervention 101 may be studied. Further examples of intervention 101 are live or recorded demonstrations, viewings, or showings of a product 100 or an intervention 101. Exemplary exposures 105 may include presentations via any medium, such as computer, television, tape, radio, live performance, or simulated intervention 101 in the real world. An exposure 105 may or may not include a hands-on opportunity to examine the product 100.

Attitude-perception-awareness (APA) block 120 represents an individual's attitudes and perceptions towards, and awareness of, the product 100 after the exposure 105 to the intervention 101. For example, one typically measures such items as brand perception or brand awareness, though many other variables may be measured. Brand perception refers to the reputation of the product 100 or of any brand, trademark, trade name, and the like, associated with the product 100. For instance, under the rubric of brand perception, dimensions may be measured such as whether people perceive the product 100 or its brand as expensive or cheap, as a good value or not, as exciting or drab, and the like. Brand awareness refers to how well the brand is known, regardless of whether it is famous or infamous. Additional variables not necessarily directly tied to the nature of the product 100, such as a subject's physiological responses, may also be measured. In an exemplary embodiment, subjects generally provide attitude-perception-awareness information by answering survey questions, though methods other than self-reporting may be used, such as physiological measurement, medical imaging, indirect monitoring, and the like; for instance, measuring changes in the subject's heart rate that occur in response to viewing pictures of brand images.

Decision block 140 represents the choice or choices made by subjects; for example, in a purchase situation. Purchase behavior is one example of a decision process resulting in a choice. Examples of consumer purchase behavior are decisions related to a purchase of products 100 such as home entertainment, electronic equipment, kitchen and laundry products, home and furniture products, utilities, clothing, tools and yard products, home office products, automobiles and transportation, sports and recreational products, gifts, or medical and healthcare products. Additional examples, particularly for “big ticket” items, include decisions related to a purchase, lease, rental, or the like of products 100 such as a house, other real estate, motorized vehicles, higher education, appliances and machinery, and other durable goods. Further examples include decisions related to purchase of products 100 comprising services, such as vacations, medical services, financial services, restaurant dining, air travel, hotels, telecommunications, entertainment, energy, and product distribution.

Influence arrow 110 represents the degree and pattern of influence the exposure block 105 has on APA block 120, and it also represents at least one mathematical function constructed to model the real-world influence process.

Influence arrow 130 represents the pattern of influence that intervening variables have on decision block 140, and it also represents at least one mathematical function constructed to model the real-world influence process. An intervening variable is any step along the purchase process, and some intervening variables may be very specific to the product 100. For instance, in an exemplary decision about buying a product 100 that is a car, an intervening variable may be willingness to take a test drive. As a further example, for buying a product 100 that is an enterprise-wide piece of software, an intervening variable may be willingness to fly a development team to headquarters for a demonstration.

Calibration arrows 115, 125 represent techniques used to map the pattern of influences observed in the laboratory to those observed in the field. For instance, it may be observed that exposure 105 to a particular intervention 101, such as an advertisement, in the laboratory environment leads to a 10% increase in brand awareness. Real world data may also be available showing that similar exposure in the field leads to only a 5% increase in brand awareness. The calibration arrows 115, 125 reflect that these differences are measured where possible and incorporated in the models developed.

FIG. 2 is a flow chart illustrating an overview of a method for modeling and predicting decisions, according to an embodiment of the invention. Results are obtained in four stages: data collection stage 200, modeling stage 210, calibration stage 220, and prediction stage 230, each of which is described in greater detail below.

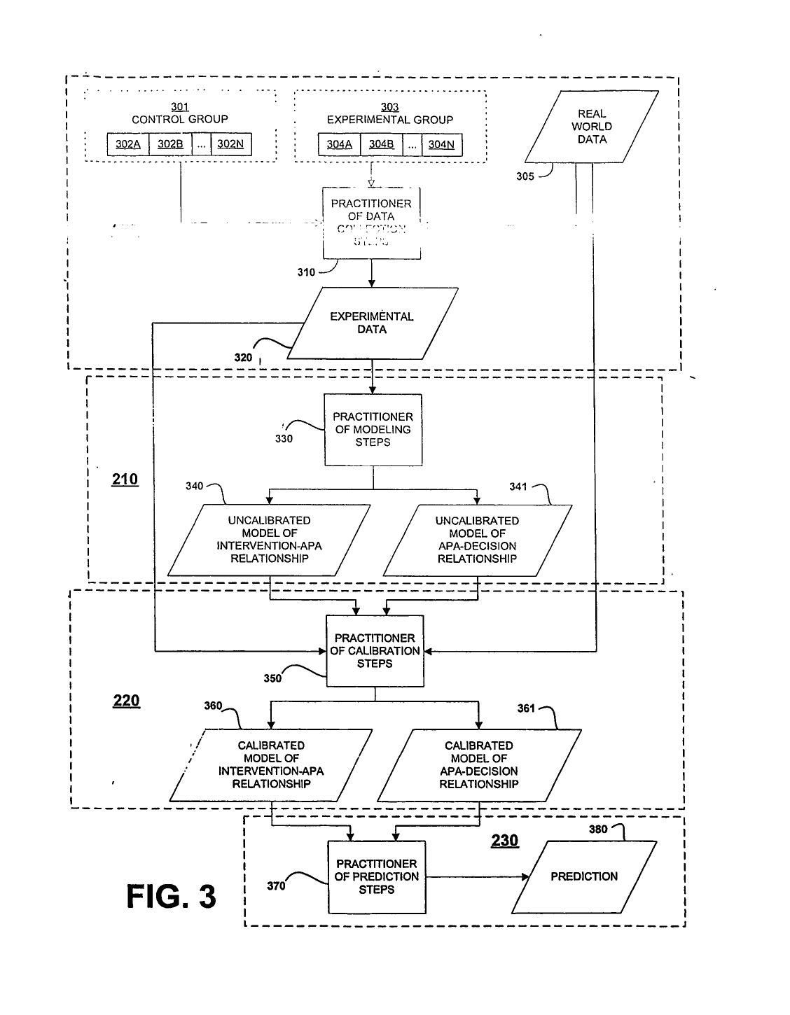

FIG. 3 is a flow chart illustrating the flow of data according to an embodiment of the invention. In data collection stage 200, a practitioner 310 collects information. The practitioner 310 may, for example, be a computer-implemented software application; a person skilled in the art of data collection, surveying, or the like; or a person assisted by a computer-implemented software application. The practitioner 310 collects information from one or more control groups 301, each comprising a plurality of control subjects 302A, 302B, . . . , 302N, collectively referred to as the control subjects 302. The practitioner 310 also collects information from one or more experimental groups 303, each comprising a plurality of experimental subjects 304A, 304B, . . . , 304N, collectively referred to as the experimental subjects 304. Control subjects 302 and experimental subjects 304 are collectively referred to as the subjects 302, 304.

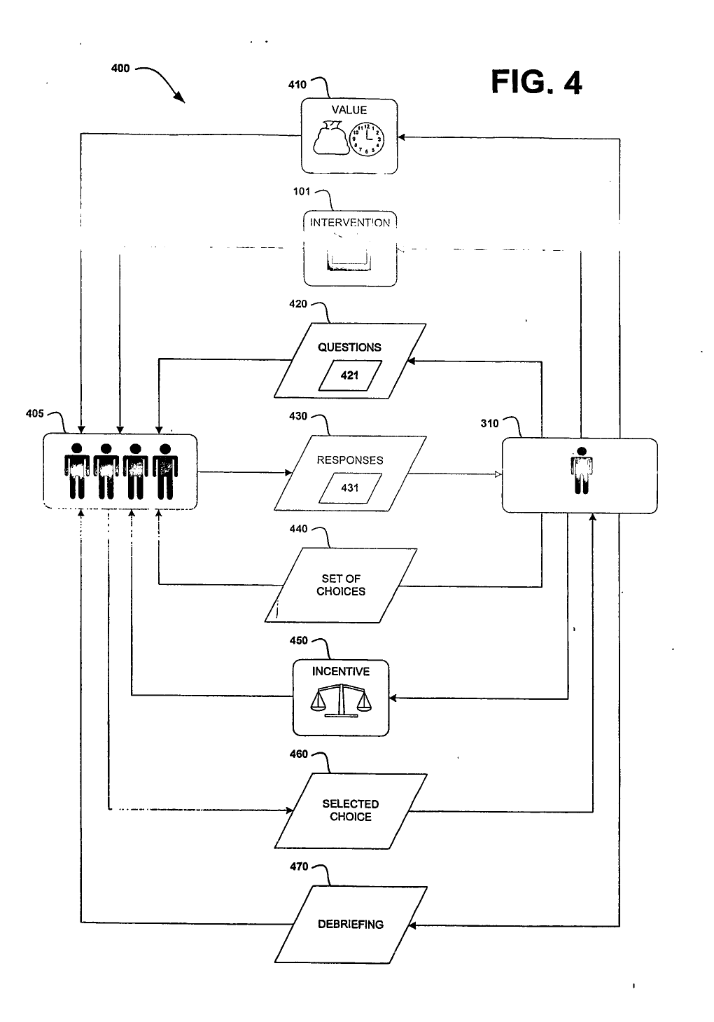

In addition, the practitioner 310 has access to real world data 305 relevant to the product 100. In an embodiment of the invention, real world data 305 may include marketing data, sales figures, product specifications, and the like, relating to the product 100, to similar or substitute products or services, or otherwise related to a relevant industry associated with the product 100. Real world data 305 may be provided to practitioner 310 by a vendor of product 100, by other organizations associated with product 100 or intervention 101, or by any of numerous third parties that monitor sales in various industries. For instance, where the product 100 is a music CD, an example of such a third party would be Nielsen SoundScan, which provides sales data for music and music video products. Using the control groups 301, experimental groups 303, and real world data 305, the practitioner 310 performs data collection steps set forth in FIG. 4 and the detailed description below. As a result of such steps, practitioner 310 obtains experimental data 320.

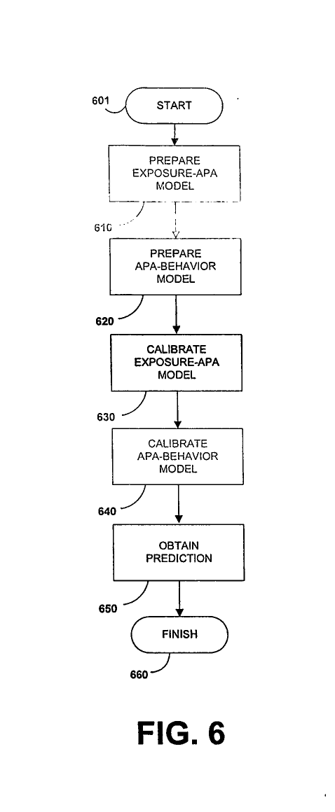

During modeling stage 210, the experimental data 320 is furnished to a practitioner 330 of modeling steps, for performing steps 610-620 as set forth in FIG. 6 and the detailed description thereof. The modeling practitioner 330 may, for example, be a computer-implemented software application; a person skilled in the art of statistical modeling, data mining, data visualization, or the like; or a person assisted by a computer-implemented software application. Modeling practitioner 330 may be, but need not be, the same as any of the other practitioners 310, 350, 370.

Modeling practitioner 330 constructs an uncalibrated model 340, comprising a mathematical model of a pattern of influence of the intervention 101 upon attitudes and perceptions towards, and awareness of, the product 100. Modeling practitioner 330 also constructs an uncalibrated model 341, comprising a mathematical model of a pattern of influence that intervening variables have on decision 140.

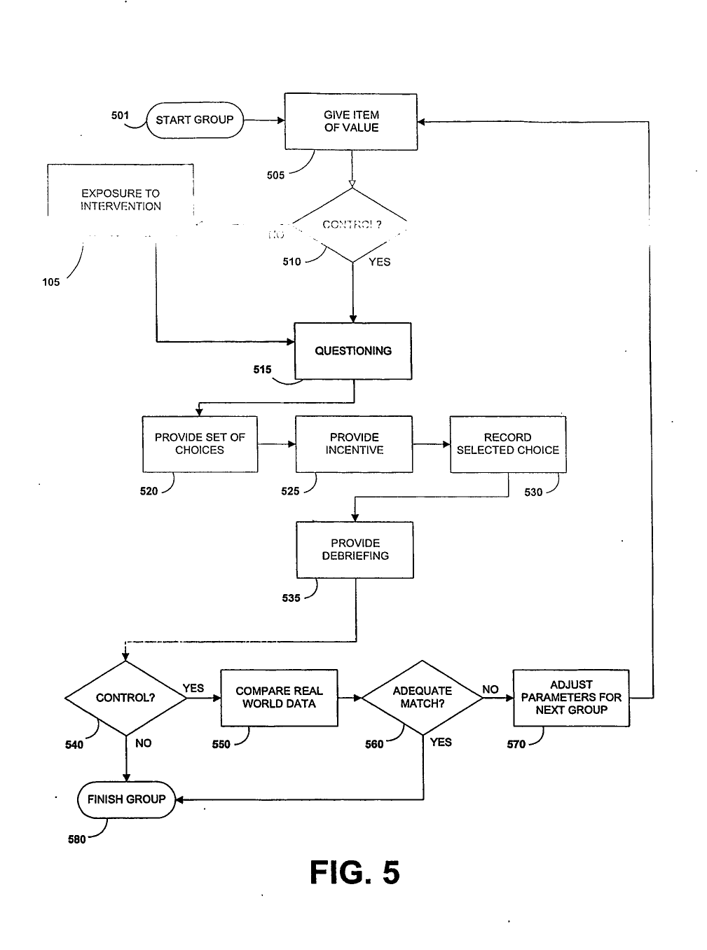

During calibration stage 220, the uncalibrated models 340, 341 are furnished to a practitioner 350 of calibration steps, for performing steps 630-640 as set forth in FIG. 6 and the detailed description thereof. In addition, during the data collection stage 200, the calibration practitioner 350 may also perform steps 550-570, which are described in FIG. 5 and the detailed description thereof found below. The calibration practitioner 350 may, for example, be a computer-implemented software application; a person skilled in the art of statistical modeling, data mining, data visualization, or the like; or a person assisted by a computer-implemented software application. Calibration practitioner 350 may be, but need not be, the same as any of the other practitioners 310, 330, 370.

Calibration practitioner 350 calibrates the behavior of groups 301, 303 in the laboratory environment with that of groups drawn from the real world data 305, using available and appropriate real world data 305 to calibrate the models 340, 341. Real world data 305 on the relationship between exposure 105 and intervening variables may be used to calibrate the uncalibrated model 340 and obtain calibrated model 360. Real world data 305 on the relationship between intervening variables and the decision 140 may be used to calibrate the uncalibrated model 341 and obtain calibrated model 361.

During prediction stage 230, the calibrated models 360, 361 are furnished to a practitioner 370 of prediction steps, for performing step 650 as set forth in FIG. 6 and the detailed description thereof. The prediction practitioner 370 may, for example, be a computer-implemented software application; a person skilled in the art of statistical modeling, data mining, data visualization, or the like; or a person assisted by a computer-implemented software application. Prediction practitioner 370 may be, but need not be, the same as any of the other practitioners 310, 330, 350. The calibrated models 360, 361 are used by prediction practitioner 370 to predict how consumers will behave in the real world, thereby obtaining a prediction 380.

FIG. 4 is a diagram of a simulated risk environment 400 according to an embodiment of the invention. The risk environment 400 includes a data collection practitioner 310, and a group 420 of subjects 302, 304 for participation in a study of one or more interventions 101. The group 420 may be a control group 301 or an experimental group 303.

The risk environment 400 includes an item of value 410, which is provided by practitioner 310 to a subject 302, 304. An exemplary item of value 410 is money, which may be provided in the form of any circulating medium of exchange, including paper money, coins, and other forms such as checks, demand deposits, and the like. Other exemplary items of value 410 are services and goods, including any tangible property having pecuniary value. Additional examples include coupons, vouchers, stored value cards, and other tokens that may be applied toward or exchanged for goods, services, or money.

As a further example of an item of value 410, time is also deemed to have value, as may be illustrated by the adage “Time is money.” In an alternative embodiment of the invention, a subject 302, 304 may be given a period of time to spend; in this instance, the period of time is the item of value 410. The period of time may be spent in any of various ways, each of which may provide more or less pleasure or utility to the subject 302, 304 than other ways of spending the period of time. The value of time may be measured, for example, by its length. The value of spent time also comprises an opportunity cost, reflecting the subjective value to the subject 302, 304 of lost opportunities to spend the time on alternative pursuits.

The risk environment 400 also includes one or more interventions 101. An intervention 101 is presented by practitioner 310 to subjects 304 in an experimental group 303, but is not presented to subjects 302 in a control group 301.

A set of questions 420 is given by the practitioner 310 to the subjects 302, 304. Questions 420 are designed to measure factors of the attitude-perception-awareness (APA) block 120. Exemplary questions 420 may measure such items as brand awareness and brand perception, though many other variables may be measured. In an embodiment of the invention, exemplary questions 420 typically include demographic data, such as age, income, education, and the like. Further questions 420 may, for example, concern the attitudes of a subject 302, 304 regarding the product 100 under question, along with similar or substitute products, such as those of competitors. Questions 420 may also concern the propensity of the subject 302, 304 to choose varieties or models in the category of the product 100; for example, the propensity to buy various car models. Any other factors that practitioners 310, 330, 350, 370 have determined to be desirable for the study, for example, based upon the possible influence of such factors on decision making or purchase behavior, will also be included among the questions 420.

In an illustrative example of question 420, rating scales may be used, such as, “Please rate the following attributes according to how important they are as you consider purchase of [the product 100]: price, quality, durability . . . ” and the like. A further example of question 420 elicits a ranking, such as, “Please choose which of the following considerations is most important to you when you purchase [the product 100]. Now please choose the next most important . . . . ” and so forth.

The questions 420 may also include a series of diversionary questions 421; for example, diversionary questions 421 may concern the personality or the finances of the subject 302, 304. While responses 430 to the diversionary questions 421 may be analyzed, the diversionary questions 420 are primarily asked to substantiate an explanation of an incentive 450 presented to subjects 302, 304. Diversionary questions 421 contribute to the successful simulation of the risk environment, as explained in further detail below.

The subjects 302, 304 furnish a set of responses 430, which may be received and recorded by the practitioner 310. The responses 430 may also include a diversionary profile 431, comprising the responses 430 to the diversionary questions 421.

The questions 420 and responses 430 may be verbal or written, and may, for example, take the form of a questionnaire, an interactive survey, or the like. In addition, while subjects 302, 304 generally provide responses 430 by answering a questionnaire or survey, methods other than self-reporting may also be used to obtain a response 430, such as physical measurements. A physical measurement may be an appropriate response 430 to a question 420 that does not call for a verbal or written answer directly from the subject 302, 304; for example, “What is the heart rate of the subject?” Relevant physical measurements may include, for example, measuring physiological changes such as heart rate, pupil dilation, and the like, that occur in response to viewing pictures of the product 100, intervention 101, brand images, or other stimuli.

The risk environment 400 further includes a set of choices 440, given by the practitioner 310 to the subjects 302, 304. The set of choices 440 represents the available choices for a decision 140. Each choice may be associated with a product 100, and with a price, the maximum price being equal to the item of value 410 given at the beginning of the experiment. The prices may be assigned by the practitioner 310, or by calibration practitioner 350. Optionally, some choices may carry identical prices. The set of choices 440 and the determination of prices associated with the set of choices 440 are among design parameters of the risk environment, which may be varied by practitioners 310, 350 during the data collecting stage 200 for control groups 301.

In an embodiment of the invention, the set of choices 440 comprise orthogonal characteristics, for analysis using conjoint statistical techniques, which are well-known to those skilled in the art. Using orthogonal characteristics, a skilled practitioner 310 may, for example, select a small set of choices 440 from which a great deal of information can be extracted. A set of choices 440 has orthogonal characteristics when the presence or absence of each characteristic is independent of the presence or absence of each of the other characteristics.

In an illustrative example of orthogonal characteristics, the practitioner 310 presents subjects 302, 304 with three or more choices of products 100 that have different characteristics or features, and the respondent chooses a selected choice 460 of the one choice they would be most likely to purchase. If the practitioner 310 were interested just in measuring the effects of three price options ($10, $20, $30), three quality options (high, medium, low), and two delivery time options (now, later), the practitioner 310 would present a set of choices 440 comprising three products 100 which differed systematically in terms of price, quality, and delivery time. If the practitioner 310 chooses carefully the set of choices 440 to be presented to subjects 302, 304, there is no need to test all possible combinations of options (3×3×2), but only a set of orthogonal combinations. Conjoint analysis allows the practitioner 310 to determine how the different options and levels of options are traded off by the subject 302, 304. An analysis of this kind is sometimes called a trade-off analysis.

A subject 302, 304 is offered the opportunity to select one of the set of choices 440, thereby providing the practitioner 310 with a selected choice 460. The set of choices 440 may optionally include a choice such as “none of the above” or the like, for recording a refusal to select any of the available options. Where subjects 302, 304 are allowed to choose such a non-selection as their selected choice 460, and do so, they may simply keep the item of value 410.

The risk environment 400 includes an incentive 450, provided by the practitioner 310 to the subject 302, 304. In an embodiment of the invention, the incentive 450 comprises a risk and a reward, such as a risk of losing at least a portion of the item of value 410, and a reward of an additional item of value 410; for example, winning more money. The risk/reward profile of incentive 450 is modeled on the risk/reward profile faced by potential buyers in the real world.

The nature of the incentive 450 is grounded in current psychological research that has helped to identify some fundamental principles of human decision making. By use of a well-chosen incentive 450, the subjects 302, 304 are presented with a real decision task that captures many of the psychologically important elements of the actual consumer purchase decision of interest. In particular, subjects 302, 304 set prices or make choices that involve real items of value 410, such as money, and that include an element of risk comparable to that faced by consumers in their everyday purchase decisions; for example, there is always uncertainty that a product 100 that is purchased may not meet the consumer's needs or expectations.

In an embodiment of the invention, each of the set of choices 440 has a price or cost associated with it, the maximum price being equal to the value of the item of value 410 given at the beginning of the experiment. When subjects 302, 304 make a selected choice 460, they are effectively making a wager that the selected choice 460, or a product 100 associated with the selected choice 460, is worth as much to them as the price, or more than the price. The set of choices 440 may optionally comprise choices having identical prices. The satisfaction of the subjects 302, 304 with their selected choice 460 is simulated by a reward built into the incentive 450; for example, paying the subject 302, 304 an amount reflecting the expected satisfaction they would receive from the chosen product 100, as determined on an experimental basis by the practitioner 310.

In one embodiment of the invention, the use of diversionary questions 421 and diversionary profile 431 contribute to the successful formulation of an incentive 450. While subjects 302, 304 are made to understand that they will not actually purchase a product 100, they are falsely instructed that, based on the profile 431 obtained from questions 421, it is possible for the practitioner 310 to determine which of the set of choices 440 is objectively the best choice for the subject 302, 304. This last statement is a deception, in that researchers do not have such an ability and, in fact, at this point, the responses 430 may not even have been analyzed or tallied. Care must be taken by the practitioner 310, so that subjects 302, 304 do not recognize these facts. The practitioner 310 goes on to provide a false description of a contingency of incentive 450. The reward of the incentive 450 is falsely described as contingent upon a match between the selected choice 460 and the previously described “objective” choice associated with the profile 431. The subjects 302, 304 are told that if they choose a selected choice 360 that well matches their profile 431, they will receive a reward above and beyond the original amount of the item of value 410. If they choose a selected choice 460 that is not a good match for their profile 431, they have a risk of losing all or a portion of the item of value 410. In an illustrative example, the subject 302, 304 might be told that they will receive a monetary reward of twice the price they paid, if their selected choice 460 reflects the best product 100 for their needs or profile 431; and, at the other extreme, a risk of receiving no money back (thereby losing at least a portion of the item of value 410) if they choose the product 100 that is least suitable for their needs or profile 431.

In an alternative embodiment, where the item of value 410 is a period of time, the incentive 450 comprises a cost and a benefit, associated with a choice, as well as an opportunity cost. An example of such a benefit may be an entertaining activity on which to spend at least a portion of time. The cost includes at least a portion of the period of time that is taken up by the entertaining activity. The opportunity cost includes at least the lost benefit associated with the one or more non-selected choices, which the subject loses the opportunity to enjoy.

The risk environment 400 also includes a debriefing 470 given by the practitioner 310. The debriefing 370 comprises information. In an exemplary debriefing 370, the subjects 302, 304 are informed of the true nature of the experiment, including information relating to the use of diversionary questions 421 and diversionary profile 431. In addition, except where the item of value 410 comprises a period of time, the item of value 410 may be returned in full to the subjects 302, 304, to keep.

### EXAMPLE 1

### Automobile Purchase Behavior

For illustrative purposes, an exemplary task of studying automobile purchase behavior will be described. However, the principles described may be applied to the analysis of any other decision, purchase, or risk-taking scenario. In the illustrative example, the product 100 is a particular model of automobile, and the item of value 410 is an amount of money; in this case, one hundred dollars. Two interventions 101 are studied, both of which are advertisements for the car. A desired prediction 380 may provide information concerning which of the two interventions 101 is more likely to increase sales of the car, relative to a control group that has not viewed any intervention 101.

Subjects 302, 304 are brought into the laboratory and given $100 in cash. They are told that this money is theirs to keep, and the subjects 302, 304 physically take possession of this item. The interventions 101 are not presented to control subjects 302, but are presented only to experimental subjects 304. Questions 420 are presented to the subjects 302, 304, eliciting responses 430 that are recorded by the practitioner 310.

For the set of choices 440, the subjects 302, 304 are told that they will have the opportunity to “buy” one of the cars under question, using the cash item of value 410 they were given at the beginning of the experiment. Subjects 302, 304 may also be allowed to make no purchase decision at all and simply keep their money. While subjects 302, 304 are made to understand that they will not actually purchase a car, they are falsely informed that, based on the diversionary profiles 431 formed from responses 430 to the diversionary questions 421 (neither of which are identified to them as “diversionary”), it is possible for researchers to determine which car is objectively the best for them.

Subjects 302, 304 are further told that any decision they make regarding this purchase carries an incentive 450 having risks and rewards. When subjects “buy” a car, they are effectively making a wager that the car is worth more to them than the value of the cash. Each car has a price associated with it, the maximum being equal to the amount of cash the subjects 302, 304 were given at the beginning of the experiment. Cars may carry identical prices. Subjects 302, 304 are told that if they choose a car that well matches their personality/financial profile they will receive a cash award above and beyond their original $100. If they choose an automobile that is not a good match for them, they risk losing all of their cash. The exact choices facing subjects 302, 304 will be unique for each study. Subjects make their decision and their selected choice 460 is recorded. In a debriefing 470, the subjects 302, 304 are informed of the true nature of the experiment, including the ruse. All subjects 302, 304 are returned the full $100 to keep.

### EXAMPLE 2

### Television Program Choice

In an illustrative example, the product 100 is a television program, and the intervention 101 is a pilot episode or an advertisement for the television program. The price one pays to watch any television program is one's time, and the missed opportunity to be doing something else, such as watching a better program. With this in mind, a set of choices 440 may be offered by giving the subjects 302, 304 a period of time 410, such as a waiting period. A pretextual explanation for the waiting period may be offered. During the waiting period, the subjects 302, 304 wait in a room with a television whose shows are limited by the practitioner 310 (for instance, by providing a library of videotapes, or a selection of viewing channels showing predetermined programs). The practitioner 310 records a selected choice 460 of what the subjects 302, 304 choose to watch as they pass the time.

### EXAMPLE 3

### Refrigerator Purchase Behavior

In an illustrative example of an embodiment of the invention, a practitioner 310, 330, 350, 370 is interested in predicting sales for a product 100 which is a new refrigerator model, relative to three comparable models from competing manufacturers. This application of EVM involves an initial stage in which general preferences for various refrigerator attributes are determined using a conjoint analysis procedure. Subjects 302, 304 are presented with a set of choices 440 comprising a series of pairs of hypothetical refrigerator models described in terms of key attributes (e.g., cost, size, freezer position, shelf arrangement, icemaker option, color), and for each pair indicate the model of product 100 they prefer. Subjects 302, 304 are paid, with an item of value 410 such as cash, for their help upon completion of this stage of the study.

In the next stage of the procedure, subjects 302, 304 are presented with information on the new refrigerator model of interest along with the three competing models. For experimental subjects 304, the information includes one or more interventions 101. Subjects 302, 304 are told that a sophisticated computer program has been used to determine which model is best suited to their own individual needs, based on their responses in the first stage of the procedure. Subjects 302, 304 are then invited to make a simulated purchase decision. Each model has an associated price, and the satisfaction of subjects 302, 304 with their choice will be simulated by paying them some amount of an item of value 410 reflecting the expected satisfaction they would receive from the chosen model. For instance, they might receive twice the price they paid if they choose the best model for their needs and, at the other extreme, receive no money back if they choose the model that is least suitable for their needs. For each refrigerator model, subjects 302, 304 would be asked to state the maximum they would pay for that model. One of the refrigerator models would be selected at random, and the price set by subject 302, 304 on that model treated as binding, and played for real money.

Data Collection Stage

During data collection stage 200, in an embodiment of the invention, at least three groups of subjects 302, 304 are used to obtain experimental data 320 and complete the study. First, at least one control group 301 is processed by the practitioner 310. Then, a plurality of experimental groups 303 are processed by the practitioner 310.

FIG. 5 is a flow chart illustrating how a practitioner 310 practices an embodiment of the invention on one more subjects 302, 304 in a control group 301 or in an experimental group 303. At start block 501, a practitioner 310 begins the study of a group 405 of one or more subjects 302, 304. The study may, for example, take place in a laboratory environment. Optionally, the subjects 302, 304 may be provided access to a computer-implemented software application, access to an Internet site, or the like, for performing portions of the data collection stage 200 in an embodiment of the invention. Such portions may include, for example, the exposure 105 to the intervention 101, or any of steps 515-535.

Steps 505-535 are repeated for each control subject 302 in a control group 301, and for each control subject 304 in an experimental group 303.

At block 505, the practitioner 310 gives the subjects 302, 304 an item of value 410. The subjects 302, 304 are told that the item of value 401 is theirs to keep. For tangible items 410, such as money or goods, the subjects 302, 304 physically take possession of the item 410. Next, at block 510, a check is performed to determine whether the subjects 302, 304 are control subjects 302 in a control group 301. If so, the paradigm proceeds directly to block 515; if not, at block 105 the experimental subjects 304 are exposed to one or more interventions 101.

At block 515, the practitioner 310 asks questions 420 to a subject 302, 304, and receives and records responses 430 from the subject 302, 304. The questions 420 may include diversionary questions 421, in which case the responses 430 include diversionary responses 431.

At block 520, the practitioner 310 provides a set of choices 440 to the subject 302, 304. At block 525, the practitioner 310 provides an incentive 450 to the subject 302, 304. At block 530, the practitioner 310 receives and records a selected choice 460. At block 540, the practitioner 310 furnishes a debriefing 470 to the subject 302, 304.

At block 540, all subjects 302, 304 have been processed for the control group 301 or experimental group 303. A check is performed to determine whether the subjects 302, 304 are control subjects 302 in a control group 301. If not, the paradigm proceeds directly to block 580, and the data collection stage 200 for this experimental group 303 is concluded. If the check indicates that a control group 303 has been processed, the paradigm proceeds to block 550.

Blocks 550-570 represent calibration of control group 301 data, which may be performed by data collection practitioner 310 or by calibration practitioner 370. Blocks 550 570 illustrate that the experiment is repeated with different control groups 301 of control subjects 302, under different experimental parameters, until laboratory decision making patterns match those observed in the real world data 305. The resulting set of experimental parameters become the base for conducting the data collection stage 200 and the steps of blocks 505-535 with experimental subjects 304 in experimental groups 303.

At block 550, the practitioner 310, 370 compares real world data 305 to the responses 430 and selected choices 460. At block 560, a check is performed to determine whether, in the view of a practitioner 310, 370 skilled in the art, there is an adequate match between the real world data 305 and the data obtained from the subjects 302, comprising responses 430 and selected choices 460. If the check at block 560 indicates that there is not an adequate match, at block 570 the practitioner 310, 370 adjusts design parameters for the next control group 301. Adjustments to the design parameters may, for example, include changes to the item of value 410, the questions 420, the set of choices 440, and the incentive 450. From block 570, the practitioner 310 proceeds back to block 505 to process another control group 301.

If the check at block 560 indicates that an adequate match has been attained, the processing of the control groups 301 concludes at block 580. Practitioner 310 may then proceed to process the one or more experimental groups 303.

Modeling, Calibration, and Predicting Stages

FIG. 6 is a flow chart illustrating modeling, calibration, and predicting steps according to an embodiment of the invention. The paradigm begins at start block 601. At this starting point, the experimental data 320 has been collected.

During modeling stage 210, two mathematical models 340, 341 are built that attempt to represent the processes indicated by the influence arrows 110, 130 (shown in FIG. 1). A skilled modeling practitioner 330 undertakes the modeling steps 610-620 to uncover meaningful relationships between the attitudinal and demographic variables measured by responses 430 to questions 420, and the type/duration/characteristics of the intervention 101.

At block 610, modeling practitioner 330 constructs an uncalibrated model 340, comprising a mathematical model of a pattern of influence of the intervention 101 upon attitudes and perceptions towards, and awareness of, the product 100. Uncalibrated model 340 corresponds to influence arrow 110. Modeling is undertaken to uncover the effect of the intervention 110 on the attitudes or behavior of the experimental subjects 304. In an embodiment of the invention, the inputs to the model represented by influence arrow 110 are drawn from experimental data 320 which may comprise, for example, key features of the exposure 105 to intervention 101 as determined by the researchers, such as number of exposures 105, recall score, or presentation channel. The outputs of the model represented by influence arrow 110 are estimated responses 430 to the questions 420.

At block 620, modeling practitioner 330 constructs an uncalibrated model 341, comprising a mathematical model of a pattern of influence that intervening variables have on decision 140. Uncalibrated model 341 corresponds to influence arrow 130. The inputs to the model represented by influence arrow 130 are drawn from experimental data 320 which may comprise, for example, responses 430 to the questions 420. The outputs are purchase pattern predictions.

At both blocks 610 and 620, the modeling practitioner 330 uses statistical analyses, such as those listed below, to compare the attitudes and the like of experimental subjects 304 who had been exposed to one or more interventions 101 to the control subjects 302 who had not been exposed to the interventions 101. The practitioner 330 identifies which attitudes are affected by an exposure 105 to the intervention 101, perhaps for the experimental group 303 as a whole, but more commonly in combination with a segmentation of the respondent experimental group 303 into relevant subgroups.

Illustrative examples of the types of statistical methods that may be chosen and used by the modeling practitioner 330, depending on the form of the experimental data 320 and the specific goals of the study, include regression, factor analysis, clustering algorithms, neural net processing, logistic regression, discriminant analysis, principal components analysis, genetic algorithms, and the like. Each of the foregoing techniques comprises a family of techniques, adaptable to the characteristics of the experimental data 320 and other factors of the situation. Any statistical method may be used for this task. Practitioners 330 who are skilled in the art will be guided in their choice of method by its accuracy, simplicity, ease of development, and ease of use.

In an illustrative example of an embodiment of the invention, the practitioner 330 may use factor or principal components analysis to condense the potentially large number of attitude measures into a manageable set of underlying variables. Depending on the number and complexity of the intervention 101, the practitioner 330 may, for example, use regression, logistical regression, discriminant analysis, or neural networks to uncover relationships between the intervention 101 and measured attitudes. Simultaneously, the practitioner 330 may, for example, use clustering algorithms to segment the respondent base into homogenous groups.

During calibration stage 220, the uncalibrated models 340, 341 are adjusted to map the pattern of influences observed in the laboratory to those observed in the field, as represented by the calibration arrows 115, 135 (shown in FIG. 1). Any available and appropriate real world data 305 may be used to calibrate the models 340, 341.

A skilled calibration practitioner 350 undertakes the calibration steps 630-640 to measure, where possible, some differences between experimental data 320 and real world data 305, and incorporate at least a portion of relevant findings into calibrated models 360, 361. In addition, as described above at steps 550-570, the calibration practitioner 350 may adjust the risk/reward structure of the incentive 350, such as for a simulated purchase situation, to match real world data 305.

At block 630, real world data 305 on the relationship between exposure 105 to intervention 101 and intervening variables may be used for calibration at calibration arrow 115. In an illustrative example, there may be a linear relationship between the number of interventions 101 (or exposures 105 thereto) and a level of brand awareness in both the real world data 305 and the experimental data 320 from the laboratory, but the slope of that relationship may be higher in the laboratory. The calibrated model 360 may be adjusted to reflect such realities, and better align the calibrated model 360 with the real world data 305.

At block 640, real world data 305 on the relationship between intervening variables and a decision 140, such as purchase behavior, may be used for calibration at calibration arrow 135. In an illustrative example, there may be a linear relationship between brand awareness and purchase behavior in both the real world data 305 and the experimental data 320 from the laboratory, but the slope of that relationship may be higher in the laboratory. The calibrated model 361 may be adjusted to reflect such realities, and better align the calibrated model 361 with the real world data 305.

During prediction stage 230, the calibrated models 360, 361 may be used in various ways to predict the decisions 140 of individuals in the real world; for example, how consumers will behave in making their purchase decisions.

At block 650, a prediction practitioner 370 uses the calibrated models 360, 361 to obtain one or more predictions 380. Illustrative examples include, but are not limited to, the following:

1. Using the results of calibrated models 360, 361 to predict the effect of an advertising campaign on sales, compared to no campaign, and to an alternate campaign.

2. Using the results of calibrated model 360 to predict which attitudinal factors are the most readily altered.

3. Using the results of calibrated model 361 to predict which attitudinal factors are the most influential on purchase behavior.

4. Using the results of calibrated models 360, 361 to predict which of the attitudinal factors that may be altered are the most influential on purchase behavior.

An embodiment of the invention allows for a more accurate prediction 380 of purchase behavior simply by measuring changes in intervening variables such as brand perception. This is possible because once the relationship between intervening variables and purchase behavior is accurately modeled, the practitioner 370 may combine data on the influence that interventions 01 have on intervening variables with the calibrated model 361 in question, to accurately predict purchase behavior. In an illustrative example, upon completion of a calibrated model 361, a novel intervention 101 may be tested to obtain new experimental data 320 for creation of a new calibrated model 360. The new calibrated model 360 may be combined with the old calibrated model 361 to predict a decision 140, such as purchase behavior, without having to collect more experimental data 320 relating to the influence arrow 135 or calibrated model 361.

A prediction 380 may be obtained, for example, by use of techniques such as regression or discriminant analysis, and the like. In an illustrative example, by using information about how much and what kind of variability there is in the different variables of the experimental data 320 and real world data 305, and what kind of intercorrelations may exist between the variables, a skilled practitioner 370 uses regression to predict or extrapolate, as well as to explain what is in the experimental data 320 that has been collected.

The prediction step 650 is a systematic process that depends largely on mathematical characteristics of the experimental data 320 collected. In addition, there may be some role for an experienced practitioner 370 to apply previously-gained domain-specific information (for instance, knowing what has been successfully manipulated in the past), but for the most part, obtaining a prediction 380 is a statistical exercise for a practitioner 370 skilled in the art.

The prediction practitioner 370 uses the formula or formulae derived in the way described above, and adjusting for the variability in the experimental data 320 and the uncertainty inherent in making predictions 380, examines the effect of changing various of the parameters and variables. Some variables would have been found to have no effect on a decision 340 such as purchase behavior, some a small effect, and some a large effect.

At end block 660, one or more predictions 380 have been obtained, and the paradigm concludes.

As will be readily understood by one skilled in the art, a practitioner 310, 330, 350, 370 need not personally perform each step of an embodiment of the invention, but may be replaced or assisted in the performance of various aspects of the invention by other persons or tools, including assistants, surrogates, computer applications, and the like, without departing from the scope of the invention.

Although exemplary implementations of the invention have been described in detail above, those skilled in the art will readily appreciate that many additional modifications are possible in the exemplary embodiments without materially departing from the novel teachings and advantages of the invention. Accordingly, these and all such modifications are intended to be included within the scope of this invention.

1. A modeling method for predicting a decision, comprising:
simulating a risk environment for one or more control groups,
exposing one or more experimental groups to an intervention, and
simulating the risk environment for the one or more experimental groups.

2. The method of claim 1 further comprising:
constructing a first model of a relationship between the intervention and a perception,
constructing a second model of a relationship between the perception and a decision,
calibrating the first and second models using a set of real world data, and
predicting the decision using the first and second models.

3. The method of claim 1 wherein simulating a risk environment further comprises:
questioning a subject on one or more relevant factors,
offering to the subject a plurality of choices for the decision,
offering to the subject an incentive, and
recording a selected choice made by the subject.

4. The method of claim 3 wherein the step of simulating a risk environment for one or more control groups further comprises:
determining whether a set of experimental data for a first control group sufficiently matches a set of real world data, and if not,
(a) adjusting one or more design parameters for a second control group, and
(b) simulating the risk environment for the second control group.

5. The method of claim 4 wherein the one or more design parameters comprise the incentive.

6. The method of claim 4 wherein the one or more design parameters comprise at least a portion of the plurality of choices.

7. The method of claim 4, the plurality of choices having a set of orthogonal characteristics, wherein the step of adjusting further comprises:
conjointly analyzing the set of experimental data with the set of orthogonal characteristics.

8. The method of claim 3 wherein the plurality of choices comprises at least one product choice and a non-selection choice.

9. The method of claim 3 further comprising providing an item of value to a subject, and wherein the incentive comprises:
a risk of losing at least a portion of the item of value, and
a reward of a further item of value.

10. The method of claim 3 wherein the item of value comprises money.

11. The method of claim 3 further comprising providing a period of time to a subject, wherein the incentive comprises:
a benefit associated with the selected choice,
a cost associated with the selected choice, the cost comprising at least a portion of the period of time, and
an opportunity cost comprising a lost benefit associated with one or more non-selected choices.

12. The method of claim 3 further comprising:
questioning the subject on one or more diversionary factors,
falsely describing a profile associated with the diversionary factors,
falsely describing a contingency of the incentive upon a match between the selected choice and an objective choice associated with the profile.

13. The method of claim 1 further comprising calibrating the risk environment.

14. The method of claim 1 wherein the decision relates to a financial transaction.

15. The method of claim 1 wherein the decision relates to a consumer purchase.

16. A method for modeling decision making behavior, comprising:
providing a simulated risk environment to one or more control groups,
calibrating the simulated risk environment against a set of real world data,
providing an intervention to one or more experimental groups,
providing the simulated risk environment to the one or more experimental groups,
modeling a relationship between the intervention and a perception,
modeling a relationship between the perception and a decision,
calibrating one or more models against the set of real world data, and
obtaining one or more predictions using the one or more models.

17. The method of claim 16 wherein providing the simulated risk environment further comprises:
questioning a subject on one or more relevant factors,
offering to the subject a plurality of choices for the decision, the plurality of choices comprising at least one product choice and a non-selection choice,
offering to the subject an incentive, and
recording a selected choice made by the subject.

18. The method of claim 16 wherein the step of calibrating the simulated risk environment further comprises:
determining whether a set of experimental data for a first control group adequately matches at least a portion of the set of real world data, and if not,
(a) adjusting one or more design parameters of the simulated risk environment, and
(b) providing the simulated risk environment to a second control group.

19. The method of claim 18 further comprising offering to the subject a plurality of choices for the decision, the plurality of choices having a set of orthogonal characteristics, wherein the step of adjusting further comprises conjointly analyzing the set of experimental data with the set of orthogonal characteristics.

20. A risk environment system for modeling a decision of a participant, comprising:
an item of value,
at least one intervention,
a plurality of questions comprising at least one non-diversionary question and at least one diversionary question,
a plurality of choices comprising at least one product choice and a non-selection choice, and
an incentive comprising a risk associated with a selected choice and a reward associated with the selected choice.

21. A simulated risk environment system for modeling a behavior of one or more subjects, comprising:
at least one intervention,
a plurality of questions,
a plurality of choices for spending a period of time, and
an incentive to a subject comprising:
(a) a benefit associated with a selected choice,
(b) a cost associated with the selected choice, the cost comprising at least a portion of the period of time, and
(c) an opportunity cost comprising a lost benefit associated with one or more non-selected choices.

22. A computer-readable storage medium containing a set of instructions for simulating a risk environment for one or more subjects, the instructions comprising:
a code segment for presenting to a subject questions on one or more relevant factors,
a code segment for offering to the subject a plurality of choices for a decision,
a code segment for offering to the subject an incentive, and a code segment for recording a selected choice made by the subject.

23. The computer-readable storage medium of claim 22, the instructions further comprising:
a code segment for questioning the subject on one or more non-relevant factors,
a code segment for falsely describing a profile associated with the non-relevant factors,
a code segment for falsely describing a contingency of the incentive upon a match between the decision and an objective decision associated with the profile.

24. A computer-implemented system for modeling at least one effect of an intervention, comprising a computer, and one or more software applications that comprise steps for:
presenting to a subject questions on one or more relevant factors,
offering to the subject a plurality of choices for a decision,
offering to the subject an incentive,
recording a selected choice made by the subject,
constructing a first model of a relationship between the intervention and a perception,
constructing a second model of a relationship between the perception and a behavior,
calibrating the first and second models using a set of real world data, and
obtaining at least one prediction using the first and second models.

25. The system of claim 24 wherein the one or more software applications further comprise steps for exposing the subject to the intervention.

26. The system of claim 24 wherein the decision relates to voting.

27. The method of claim 1 wherein the decision relates to voting.

28. The method of claim 16 wherein the decision relates to voting.
